(19) United States
(12) Patent Application Publication
(10) Pub. No.: US 2009/0152838 A1
(43) Pub. Date: Jun. 18, 2009

(54) AIRBAG INFLATOR DEVICE AND METHOD OF INSTALLATION

(75) Inventor: Erik Robins, Farmington Hills, MI (US)

Correspondence Address: YOUNG & BASILE, P.C., 3001 WEST BIG BEAVER ROAD, SUITE 624, TROY, MI, 48084, US

(73) Assignee: NISSAN TECHNICAL CENTER NORTH AMERICA, INC., Farmington Hills, MI (US)

(21) Appl. No.: 11/957,550

(22) Filed: Dec. 17, 2007

(51) Int. Cl. B60R 21/217; B60R 21/213

(52) U.S. Cl. 280/728.2

(57) ABSTRACT

A vehicle having and airbag inflator device and method of installation is disclosed. The airbag inflator device is positioned in a recess in a body structure roof rail or enclosed in an interior cavity defined by the roof rail member. The airbag inflator is mounted to the roof rail directly or to a cover plate that when installed forms a part of the roof rail substantially covering an aperture in the roof rail.

### FIELD OF THE INVENTION

The invention generally pertains to inflatable airbag restraint systems for use in passenger vehicles.

### BACKGROUND

Protective airbag restraint systems for use in automotive passenger applications have become standard equipment on almost all new vehicles sold in the United States and are common equipment on vehicles manufactured and sold throughout the world. In recent years, inflatable side curtain airbags positioned along side roof rails above the occupant side doors that extend downward to further protect the occupants have grown in use due to their ability to provide additional protection in these areas.

It has been a challenge for automotive manufactures to package and conceal the mechanical components of the restraint systems, including the inflatable airbags and the airbag inflator which provides the fluid, typically a gas, to inflate the airbags in the roof rail or A-pillar areas of the sheet metal structure of the vehicle. The airbag restraint system components have typically been concealed from occupant view behind interior trim panel components. In order to provide adequate packaging space for the airbag components, the panels must be relevantly large and naturally protrude into the passenger compartment reducing the amount space for the occupants.

An airbag restraint system component that is particularly difficult to package and conceal from occupant view is the airbag inflator. The inflator is typically a relatively large and rigid cylindrical canister that must be rigidly attached to the body structure and be positioned to minimize contact by an occupant during an impact event. The packaging and positioning of the inflator canister must not compromise the principal function of providing a sufficient path for the fluid to pass from the canister to the airbag for rapid deployment.

### SUMMARY

The present invention is an inflatable restraint system for a passenger vehicle including a vehicle body structure having a roof rail and an inflatable restraint system secured to the body structure. In one example of the invention, the body structure is a roof rail including an outer roof rail and an inner roof rail member. The inner roof rail member includes an inboard facing surface positioned toward the interior of a passenger compartment.

In an example of the invention, the inner roof rail member includes a first aperture in the inboard facing surface and a separate cover plate which is configured and positioned to substantially cover the first aperture when connected to the inner roof rail member. In this example, the inflator canister is securely attached to the cover plate which is then installed over the first aperture. The cover plate is then securely connected to the inner roof rail member thereby positioning the inflator canister in an interior cavity of the roof rail defined by the inner roof rail and outer roof rail members. In this example, the entire inflator canister is concealed within the roof rail with the possible exception of a gas guide that may extend through the cover plate to place the concealed inflator canister in fluid communication with the inflatable airbag positioned and attached to the inboard facing surface of the inner roof rail member.

In another example of the invention, the inflatable airbag restraint system includes an inflatable airbag that is connected to the body structure and an inflator in fluid communication with the airbag. The roof rail inner member includes a recess formed in the inner roof rail member extending outward toward the outer roof rail member. At least a portion of the inflator is positioned in the recess to reduce the amount of the remaining inflation canister from extending beyond the inboard facing surface toward the passenger compartment. In one example of the invention having a recess for receipt of at least a portion of the inflator canister, at least 30% of a side profile or diameter of the canister is positioned or concealed within the recess.

In alternate examples of the invention, the inflator is secured to either the cover plate or the inner roof rail member by a retainer. In one example of the retainer, a retainer strap is used to securely connect the inflator canister to the cover plate forming an integrated inflator assembly. In another example of the retainer, one or more clamps are used to position and secure the inflator canister in the recess.

Methods of installing the inflator include positioning and securing at least a portion of the inflator either in an interior cavity in the roof rail or in a recess formed in the inner roof rail member.

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1 is a cut-away perspective view of one example of the invention showing the inflator positioned in an interior cavity behind a cover plate;

FIG. 2 is a side view of the cut-away perspective view of the invention shown in FIG. 1;

FIG. 3 is an alternate example of the invention shown in FIG. 1 having a smaller cover plate;

FIG. 4 is an alternate example of the invention in FIG. 1 showing the inflator partially positioned in a recess and including an example of retainers that may be used;

FIG. 5 is a side view of the invention shown in FIG. 4; and

FIG. 6 is an alternate example of the invention shown in FIG. 4 illustrating almost the entire inflator concealed in a recess in the inner roof rail member.

### DETAILED DESCRIPTION

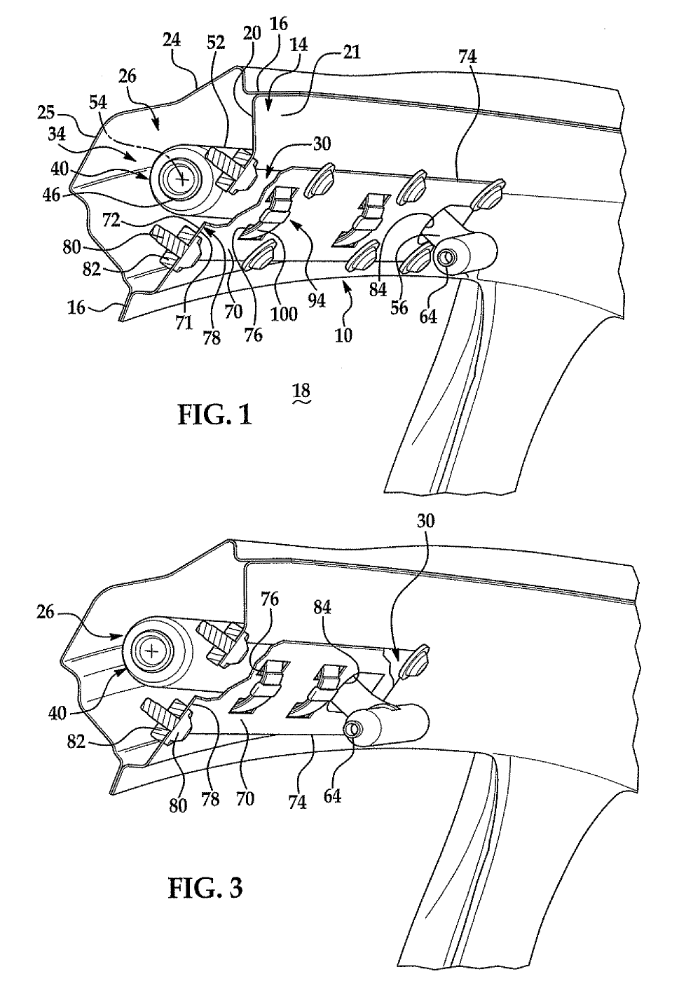

Referring to FIGS. 1-6, examples of an airbag inflator device and methods of installation are illustrated and described below. Referring to FIG. 1, an example of an inflator device 10 used in an exemplary application in a passenger vehicle roof rail 14 positioned above a driver's side door 18 is illustrated. Inflator 10 may be positioned in other locations along the roof rail 14 and in different positions in relation to other structural pillars than as illustrated.

In FIG. 1, the roof rail 14 includes an inner roof rail member 20 and an outer roof rail member 24. The inner 20 and outer 24 roof rail members are attached to one another along flanges 16 by spot welding, seam welding or other attaching methods known by those skilled in the art. Inner roof rail member 20 includes an inboard facing surface 21 directed toward the interior compartment of a vehicle (not shown). Outer roof rail member 24 includes an outer surface 25 directed toward the exterior of a vehicle (not shown). Inner 20 and outer 24 roof rail members are preferably stamped, cold rolled steel in a suitable shape to fit the particular application in a vehicle.

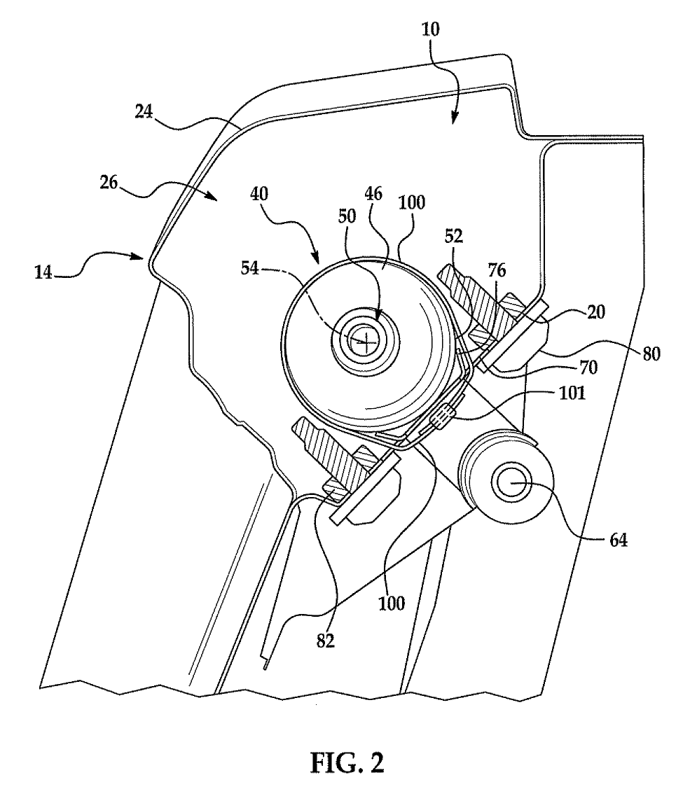

In a preferred example, inner roof rail member 20 and outer roof rail 24 form an interior cavity 26 between the members. The size, shape and orientation of interior cavity 26 may vary along the length of the roof rail to suit the particular application. In a preferred example of the invention shown in FIG. 1, the inboard facing surface 21 of the inner roof rail member 20 includes a first aperture 30 in communication with interior cavity 26. As shown in FIGS. 1 and 2, an inflatable airbag restraint system is illustrated including an inflator 40 which may include a cylindrically-shaped canister 46. Canister 46 includes a first end (not shown), a second end 50 and an outer wall 52 generally defining a longitudinal axis 54 along the length of canister 46. Inflator canister 46 is preferably cylindrical in shape and may be made from steel or aluminum suitable for containment of compressed, high pressure fluid such as a gas.

In the example of the invention shown in FIGS. 1 and 2, a gas guide 56 may be used. Gas guide 56 is preferably a hollow, tubular-shaped member connected to first end 48 of inflator canister 46 permitting the flow of fluid from canister 46 through the gas guide 56 to an inflatable airbag (not shown) positioned adjacent to the inboard facing surface 21 of inner roof rail member 20. Gas guide 56 is shown extending at a substantially perpendicular angle to inflator canister 46. It is understood that other angles and orientations of gas guide 56 may be used as known by those skilled in the art.

Continuing with the invention shown in FIG. 1, inner roof rail member 20 further includes a separate cover plate 70 which is sized and configured to substantially cover the first aperture 30 when installed. Cover plate 70 includes a first surface 71 directed toward the interior of the vehicle passenger compartment (not shown) and an opposing second surface 72 directed toward interior cavity 26 and outer roof rail member 24. The cover plate 70 shown in FIG. 1 includes a length 74 which, in a preferred example, is greater than the length of inflator canister 46 including any additional length as added by gas guide 56. Cover plate 70 further includes a width 78. As described above, length 74 and width 78 are preferably sufficient to substantially cover first aperture 30 including any material necessary to allow for fasteners to secure cover plate 70 to roof rail 14. Cover plate 70 is preferably made from the same material as roof rail 14 as previously described but may be made from other materials suitable for the application as known by those skilled in the art.

Cover plate 70 includes at least two, and preferably four, through-tabs 76 which are best seen in FIGS. 1 and 2. Tabs 76 are preferably stamped or punched through first surface 71 bending the still-attached tab 76 inward toward interior cavity 26 at an angle as best seen in FIG. 2. Tabs 76 are positioned and oriented on cover plate 70 to assist in the location and position of inflator canister 46 for secure attachment which is described below.

As best seen in FIG. 2, in a preferred example of the invention shown in FIGS. 1 and 2, inflator canister 46 is securely attached to cover plate 70 prior to installation of the inflator 40 in, and cover plate 70 on, roof rail 14. In one example of the invention, a retainer 94 is used to securely attach inflator canister 46 to cover plate 70 to form an integral inflator assembly for mounting to the roof rail 14. In the example shown in FIGS. 1 and 2, retainer 94 may include a cinch-locking strap 100. In one example, strap 100 is an elongate flexible spring steel strap that is threaded through the openings in cover plate 70 created by vertically aligned tabs 76 and positioned around inflator canister 46. Strap 100 includes a lock 101 which is positioned near one end of the strap 100 and receives the opposing end of the strap. The loose end is threaded through the lock 101 which allows only one-way movement of the loose end of the strap through the lock preventing reverse movement back out of the lock similar to a plastic zip-strip-type fastener commonly known by those skilled in the art. The more the loose end of strap 100 is pulled through the lock, the higher the compression force is placed on canister 46 thereby securely attaching it to cover plate 70. As shown in FIG. 1, one or more straps 100 may be used (two shown). It is understood that more or less straps may be used to suit the particular application. It is further understood that other fastening mechanisms such as mechanical fasteners including screws, bolts, brackets, (all not shown) may be used alone or with other fasteners as known by those skilled in the art.

As shown in FIGS. 1 and 2, if a gas guide 56 is used, a notch or clearance hole 84 in cover plate 70 may be used to provide a pathway for gas guide 56 to pass from inflator 40 through cover plate 70. On actuation of inflator 40, fluid rapidly flows from inflator 40 through gas guide 56 through exit ports 64 to an airbag (not shown).

On secured attachment of inflator 40 to cover plate 70, an integrated inflator assembly is created. Integrated inflator assembly may then be attached to roof rail 14, and preferably inner roof rail member 20, to substantially cover first aperture 30 to completely conceal inflator canister 46 inside roof rail 14 thereby eliminating the packaging challenge existing in the art for the inflator. This is accomplished by positioning inflator 40 through first aperture 30 into interior cavity 26. The cover plate 70 is then securely attached to inner roof rail member 20 through fasteners 80. In a preferred example, fasteners 80 are threaded bolts used with weld nuts 82 positioned on the inner roof rail member 20 surface facing interior cavity 26 as best seen in FIG. 2. In a preferred example, cover plate 70 and fastener 80 substantially restore the structural integrity of roof rail 14 by substantially covering first aperture 30. It is understood that other fastening methods other than bolts and weld nuts, for example, self-drilling or self-tapping screws, or other processes such as staking, may be used to secure cover plate 70 to roof rail 14 as known by those skilled in the art. It is further understood that other structures such as brackets and formations in the components such as darts to reinforce the areas known by those skilled in the art may be used.

Referring to FIG. 3, an alternate example of the invention shown in FIGS. 1 and 2 is illustrated. In this example, aperture 30 and cover plate 70 length 74 are reduced to a length smaller than the length of inflator 40 including any length added by gas guide 56. Attachment of inflator 40 to cover plate 70 may be similar to that previously described in FIGS. 1 and 2. On installation of the integrated inflator assembly, including cover plate 70 and inflator 40, inflator 40 is angled and orientated through the smaller first aperture 30 to position inflator 40 in interior cavity 26 as previously described. Cover plate 70 is then secured to inner roof rail member 20 by fasteners 80 as previously described.

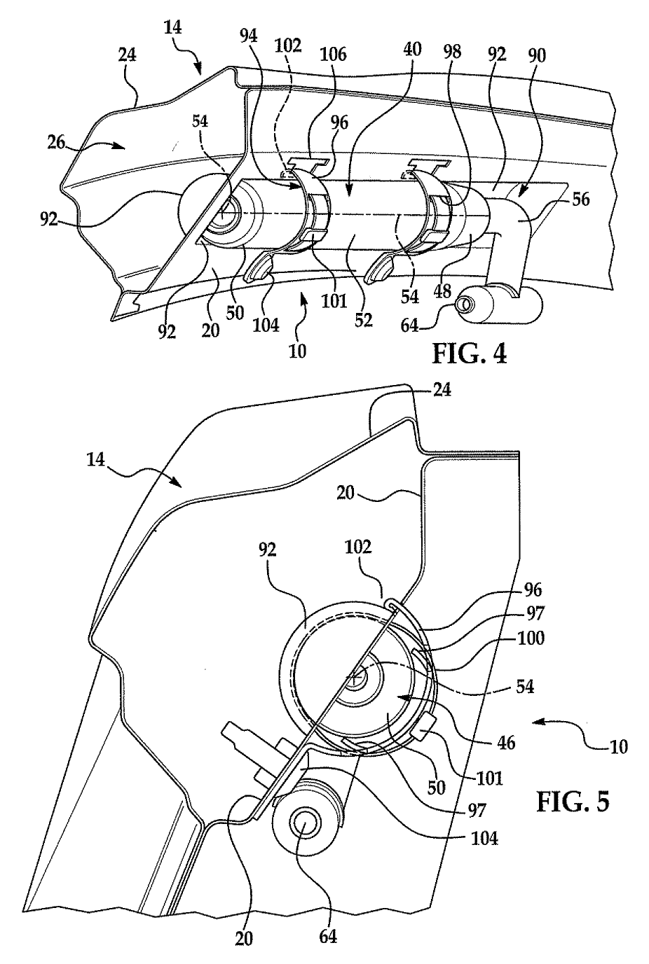

Referring to FIGS. 4 and 5 and alternate example of the invention is illustrated. In the example, roof rail 14 generally includes an inner roof rail member 20 and an outer roof rail member 24 forming an interior cavity 26 as well as an inflator 40 and a gas guide 56 as previously described. In this example, a recess 90 is stamped or formed into inner roof rail member 20 deforming the substrate material inward toward interior cavity 26 and outer rail 24 forming an inner wall 92 as best seen in FIG. 5.

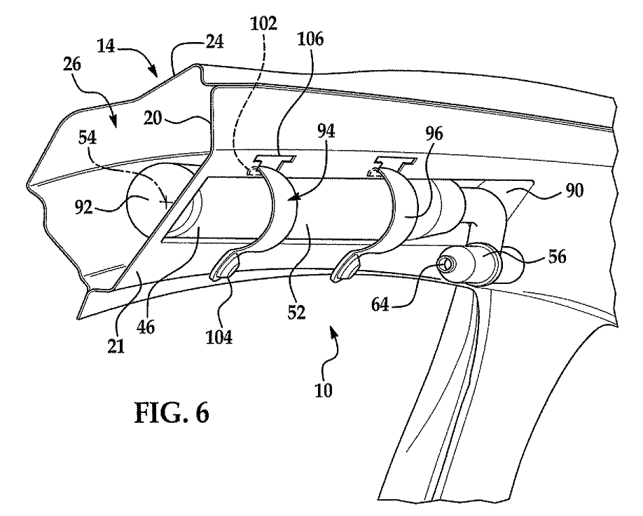

Recess 90 is sized and configured to accept the full length of inflator canister 46 in a direction along longitudinal axis 54 including any additional length added by gas guide 56. In a preferred example, recess 90 is further lengthened by 30 to 50 millimeters along the longitudinal axis 54 to provide clearance for a wire harness or electrical connector extending from inflator 40 to an inflatable restraint system controller (not shown) which initiates activation of inflator 40 to inflate the airbag on an impact event. Recess 90 is configured to extend into interior cavity 26 to accept and conceal at least a portion of a profile or diameter of canister 46 from the inboard facing surface 21 of inner roof rail 20 as best seen in FIG. 5. In a preferred example, at least 30% of the inflation canister 46 profile, or as shown in FIG. 5 a diameter, is received or concealed in recess 90. It is understood that the depth of recess 90 may vary to receive less, or as shown in FIG. 6, more of the inflator as more fully described below.

Referring to the example shown in FIG. 6, one or more retainers 94 may be used to secure the inflator 40 to roof rail 14. In one example, one or more clamps 96 are used as generally illustrated. Clamps 96 may include an enlarged flange 102 at one end that is inserted in a keyhole slot 106 or other suitable opening formed in inner roof rail member 20. The enlarged flange 102 is inserted through slot 106 and the remainder of clamp 96 is wrapped around the outer wall 52 of canister 46 and secured at an opposite end, and on the opposing side of, recess 90 and secured to inner roof rail member 20 through fasteners 80 in a matter previously described. Clamps 96 may be made from stamped or formed, relatively rigid steel or may be made from flexible spring steel or other materials known by those skilled in the art.

In an alternate example of retainer 94, FIGS. 4 and 5 illustrate that clamps 96 may further include tabs 97 similar to tabs 76 in the example shown in FIGS. 1 and 2 and include a strap 100 that wraps around canister 46 to secure inflator 40 to clamp 96 prior to installation in roof rail 14. In the example, straps 100 are positioned through holes 98 formed by the cut-through tabs 97 and secured around inflator 40 by lock 101 as generally shown in FIG. 2. It is understood that other methods for attaching inflator 40 to roof rail 14 and for attaching inflator 40 to clamps 96 may be used as known by those skilled in the art.

Referring again to FIG. 6, an alternate example of the invention shown in FIGS. 4 and 5 is illustrated. In this example, recess 90 is formed into inner roof rail member 20 at a greater depth into interior cavity 26 as shown. With recess 90 having a greater depth, a greater portion of the profile or diameter of inflation canister 46 may be received in the recess 90 thereby extending a lesser distance from inboard facing surface of inner roof rail member 20 toward the passenger compartment. In this example, retainer 94 is shown in the form of a clamp 96 as previously described. It is understood that other methods of securing inflator 40 to roof rail 14 may be used.

In a method of installing an inflatable restraint system and an airbag inflator is generally shown in FIGS. 1-6 and as previously described. In the example shown in FIGS. 1-3, an inflator 40 is ultimately placed in fluid communication with an airbag (not shown). A roof rail 14 having an inner roof rail member 20 and outer roof rail member 24 is provided as previously described. The inflator is then mounted to the roof rail 14, preferably inner roof rail member 20.

In one example of the invention shown in FIGS. 1-3, inner roof rail member 20 includes an inboard facing surface 21 and a first aperture 30 whereby inflator 40 is positioned through aperture 30 into interior cavity 26 and cover plate 70 is secured over aperture 30 to conceal inflator 40 within roof rail 14. In one example of the invention, inflator 40 is attached to cover plate 70 prior to installation forming an integral inflator assembly.

In another example of a method of installing an inflatable restraint system and an inflator is illustrated in FIGS. 4-6. In this example at least a portion of inflator 40 is received in a recess 90 formed in inner roof rail member 20 extending into cavity 26. In one example, inflator 40 is then secured to inner roof rail member 20 by a retainer 94, preferably clamps 96.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A passenger vehicle having an inflatable restraint system comprising:
a body structure having a roof rail, the roof rail including an outer roof rail member defining an outboard facing surface of the roof rail, and an inner roof rail member connected to the outer roof rail member and defining an inboard facing surface, the inner roof rail member having a recess formed therein; and
an inflatable airbag restraint system including an inflatable airbag connected to the body structure and an inflator in fluid communication with the airbag, the airbag operable in a stowed configuration and a deployed configuration wherein the inflator inflates the airbag with a fluid;
wherein the recess is configured and arranged to receive and position a portion of the inflator extending past the inboard facing surface toward the outer roof rail member.

2. The vehicle of claim 1 wherein the recess is positioned adjacent a passenger compartment of the vehicle.

3. The vehicle of claim 1 wherein the inflatable airbag is connected to the inner roof rail member.

4. The vehicle of claim 1 wherein the airbag restraint system further comprises a gas guide in fluid communication with the inflator and the airbag.

5. The vehicle of claim 1 wherein the portion of the inflator extending past the inboard facing surface toward the outer roof rail member is at least 30% of a profile of the inflator.

6. The vehicle of claim 1 further comprising at least one retainer for securely attaching the received inflator to the inner roof rail member.

7. The vehicle of claim 6 wherein the inner roof rail member further defines a slot for engagement of a first end of the retainer having an enlarged flange, the retainer further having a second end connected to the inner roof rail member on an opposing side of the recess.

8. A passenger vehicle having an inflatable restraint system comprising:
a body structure having a roof rail, the roof rail including an outer roof rail member defining an outboard facing surface of the roof rail, and an inner roof rail member connected to the outer roof rail member and defining an inboard facing surface, wherein the outer roof rail member and inner roof rail member are configured and arranged to form an interior cavity; and
an inflatable airbag restraint system including an inflatable airbag connected to the body structure, an inflator, and a gas guide in fluid communication with the airbag and the inflator and extending through the inboard facing surface, the airbag operable in a stowed configuration and a deployed configuration wherein the inflator inflates the airbag with a fluid;
wherein the interior cavity is configured and arranged to receive the inflator.

9. The vehicle of claim 8 wherein the inner roof rail member defines a first aperture in communication with the interior cavity, wherein the inflator is positioned through the first aperture into the interior cavity.

10. The vehicle of claim 9 wherein the inner roof rail member further comprises a cover plate, wherein the inflator is connected to the cover plate forming an integrated inflator assembly.

11. The vehicle of claim 10 wherein the cover plate is connected to the inner roof rail member and configured to substantially cover the first aperture.

12. The vehicle of claim 10 wherein the cover plate further comprises at least one of a notch and a second aperture for passage of the gas guide through the cover plate.

13. The vehicle of claim 8 wherein the inner roof rail member further comprises at least one tab for positionally locating the cover plate on the inner roof rail member for connection of the integrated inflator assembly to the roof rail.

14. The vehicle of claim 10 wherein the cover plate further comprises at least two tabs for positionally locating the inflator on the cover plate for connection of the inflator to the cover plate.

15. The vehicle of claim 14 further comprising a retainer extending through the at least two tabs for secure attachment of the inflator to the cover plate.

16. A method of installing an inflatable airbag restraint system in a vehicle, the method comprising:
providing an inflator having a canister in fluid communication with an inflator gas guide;
providing a roof rail having an inner roof rail member defining an inboard facing surface configured for receiving at least a portion of the inflator through the inboard surface; and
mounting the inflator to the inner roof rail member to secure the inflator to the vehicle.

17. The method of claim 16 wherein the step of receiving the at least one portion of the inflator through the inboard surface further comprises the step of enclosing the inflator canister in an interior cavity defined by the inner roof rail member and an outer roof rail member.

18. The method of claim 17 further comprising the steps of:
providing the inner roof rail member with a first aperture in communication with the interior cavity and a cover plate;
connecting the canister to the cover plate forming an integrated inflator assembly;
inserting the canister through the first aperture into the cavity; and mounting the cover plate to the inner roof rail member to substantially cover the first aperture.

19. The method of claim 16 wherein the step of receiving at least a portion of the inflator through the inboard surface further comprises the step of positioning the at least a portion of the inflator canister in a recess in the inner roof rail member to reduce the extension of the canister beyond the inboard facing surface into a vehicle passenger compartment.

20. The method of claim 16 further comprising the steps of:
providing an inflatable airbag in fluid communication with the inflator; and
connecting the airbag to the inner roof rail member.
